(19) United States
(12) Patent Application Publication
(10) Pub. No.: US 2004/0090969 A1
(43) Pub. Date: May 13, 2004

(54) Portlet data sharing system, method, and program product

(75) Inventors: Stanley K. Jerrard-Dunne, Leopardstown (IE); Glen E. Salmon, Amesbury, MA (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/292,074

(22) Filed: Nov. 12, 2002

(51) Int. Cl. H04L 12/28

(52) U.S. Cl. 370/395.54

(57) ABSTRACT

A system, method and program product for sharing data between portlets. The invention allows for the creation of a portal page that includes a first portlet and a second portlet, wherein a source field in the first portlet is mapped to a destination field in the second portlet so that the data in the source field is automatically shared with the destination field.

### BACKGROUND OF THE INVENTION

1. Technical Field

The present invention generally relates to portals and portlets. Specifically, the present invention provides a portlet data sharing system, method, and program product that allow increased flexibility and reusability in sharing data between portlets.

2. Background Art

As the use of the Internet becomes more pervasive, better technology is constantly being developed for displaying web content. To this extent, portal servers have become the technology of choice in delivering web content to users. Typically, a portal server includes a portal program (e.g., WEBSPHERE from International Business Machines Corp. of Armonk, N.Y.), which arranges web content into a portal page containing one or more portlets. Each portlet includes a section of web content specified according to a user's preferences. For example, a user can establish his/her own portal page that has portlets for news, weather and sports. The portal program can obtain the desired web content from an appropriate content provider, aggregate the web content, and then display the web content in the appropriate portlets as a portal page. This portal technology has lead to the explosion of personalized “home pages” for individual web users.

Developers have begun to apply the portlet technology for commercial applications. For example, a portal page can be used to customize a page for an employee, customer, supplier, etc. In these applications, data presented in the portlets is often related. For example, data in a “destination city” field of a travel portlet could be shared with a “target city” field of a weather portlet. In current implementations, a portlet can share data with another known portlet by using messaging or passing parameters. However, the portlet developer must have detailed knowledge of all participating portlets in order to implement the data sharing. Further, the decision of whether to share data, and what data to share is fixed when a portlet is developed. These limitations restrict the reusability and interoperability of portlets.

In view of the foregoing, there exists a need for a portlet data sharing system, method and program product. In particular, there exists a need for a system, method and program product that allow developers to define access to data within a portlet that can be shared with zero or more other portlets, without knowledge of the other portlets. Further, there exists a need for portlets that allow a user or developer to define the data sharing between portlets. These features provide portlets that are more flexible and reusable in various applications.

### SUMMARY OF THE INVENTION

The current invention provides a method, system, and program product for sharing data among two or more portlets. The invention allows a portlet developer to define data fields that are to receive and/or share data with other portlets without any knowledge of the other portlets. This beneficially increases the reusability of portlets, and increases the flexibility in which portlet data sharing can be defined and implemented.

A first aspect of the invention provides a system for sharing data between portlets, comprising a mapping system for mapping a source field in a first portlet to a destination field in a second portlet, wherein data in the source field is shared with the destination field.

A second aspect of the invention provides a method of sharing data between portlets, comprising: providing a first portlet and a second portlet; mapping a source field in the first portlet to a destination field in the second portlet; and sharing data in the source field with the destination field.

A third aspect of the invention provides a computer program product comprising a computer useable medium having computer readable program code embodied therein for sharing data between portlets, the program product comprising: program code configured to define a first portlet having a source field and a second portlet having a destination field; and program code configured to map the source field to the destination field, wherein data in the source field is shared with the destination field.

The exemplary aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a block diagram of a system according to one aspect of the invention;

FIG. 2 depicts an illustrative portal page generated according to one aspect of the invention;

FIG. 3A depicts a graphical user interface for defining the shared data for the portal page of FIG. 2 according to another aspect of the invention; and

FIG. 3B depicts a character-based user interface for defining the shared data for the portal page of FIG. 2 according to yet another aspect of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The current invention provides a system, method, and program product for sharing data between portlets. Specifically, the invention provides a portlet developer with the ability to define one or more data fields that can receive and/or share data with fields of other portlets. Specifically, a portal developer can map a source field in a first portlet to a destination field in a second portlet. Once mapped, the data in the source field is automatically shared with the destination field.

It is understood that, as known in the art, the term “portlet” refers both to the visual sections of a portal page, as well as to the program code used to obtain and aggregate the content therein for display in the visual sections. Thus, a portlet should be understood to have at least two manifestations: (1) a visual portlet displayed as part of a portal page; (2) and a portlet program that includes the program code for obtaining the content displayed in the visual portlet.

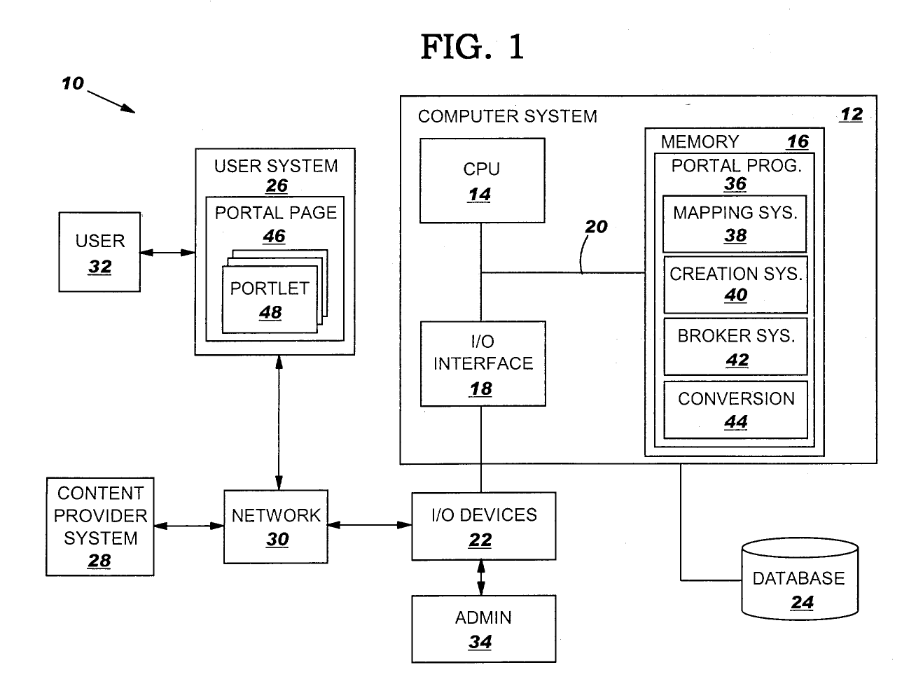

Turning to the figures, FIG. 1 depicts a portlet data sharing system 10 according to one aspect of the invention. System 10 includes a computer system 12 that generally comprises a central processing unit (CPU) 14, memory 16, input/output (I/O) interface 18, bus 20, I/O devices 22 and database 24. User system 26 and content provider system 28 are shown in communication with computer system 12 by interfacing with one or more I/O devices 22 of computer system 12 via a network 30 (e.g., LAN, WAN, Internet, etc.). It is understood that although not shown, user system 26, and content provider system 28 typically contain components (e.g., CPU, memory, etc.) similar to computer system 12. Such components have not been separately depicted and described for brevity purposes. In addition, it should be understood that computer system 12, user system 26 and content provider system 28 comprise any type of device capable of accepting input, providing output, and communicating with another device. To this extent, computer system 12 represents any type of computerized system for providing access to a web site (e.g., a web server), user system 26 represents any type of computerized system that can be used to access the world wide web (e.g., a mobile phone, a handheld computer, a personal digital assistant, a portable (laptop) computer, a desktop computer, a workstation, a mainframe computer etc.), and content provider system 28 represents any type of computerized system for providing data to other systems.

Communications between user system 26, computer system 12, content provider system 28, and/or network 30 can occur via one or more direct hardwired connections (e.g., serial port), or via an addressable connection in a client-server (or server-server) environment which may utilize any combination of wireline and/or wireless transmission methods. In the case of the latter, the server and client may be connected via the Internet, a wide area network (WAN), a local area network (LAN), a virtual private network (VPN), or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

Computer system 12 can comprise any general purpose or specific-use system utilizing standard operating system software, which is designed to drive the operation of the particular hardware and which is compatible with other system components and I/O controllers. CPU 14 may comprise a single processing unit, multiple processing units capable of parallel operation, or be distributed across one or more processing units in one or more locations, e.g., on a client and server. Memory 16 may comprise any known type of data storage and/or transmission media, including magnetic media, optical media, random access memory (RAM),. read-only memory (ROM), a data cache, a data object, etc. Moreover, similar to CPU 14, memory 16 may reside at a single physical location, comprising one or more types of data storage, or be distributed across a plurality of physical systems in various forms.

I/O interface 18 may comprise any system for exchanging information with one or more I/O devices 22, including an I/O port (serial, parallel, ethernet, keyboard, mouse, etc.), an universal serial bus (USB) port, expansion bus, integrated drive electronics (IDE), etc. I/O devices 22 may comprise any known type of input/output device capable of communicating with I/O interface 18 with or without additional devices (i.e., expansion cards), including a network system, a modem, speakers, a monitor (cathode-ray tube (CRT), liquid-crystal display (LCD), etc.), hand-held device, keyboard, mouse, voice recognition system, speech output system, scanner, printer, facsimile, pager, storage devices, etc. Bus 20 provides a communication link between each of the components in computer system 12 and likewise may comprise any known type of transmission link, including electrical, optical, wireless, etc. In addition, although not shown, additional components, such as cache memory, communication systems, system software, etc., may be incorporated into computer system 12.

Database 24 may provide storage for information necessary to carry out the present invention as described in more detail below. As such, database 24 may include one or more storage devices, such as a magnetic disk drive or an optical disk drive. Further, database 24 can include data distributed across, for example, a LAN, WAN or a storage area network (SAN) (not shown). Database 24 may also be configured in such a way that one of ordinary skill in the art may interpret it to include one or more storage devices.

As shown, a user 32 interacts with portlet data sharing system 10 through user system 26. An administrator 34 interacts with portlet data sharing system 10 directly using one or more I/O devices 22, or in a fashion similar to user 32 (e.g., over network 30). In practice, user 32 can be limited to certain functions provided by system 10, whereas administrator 34 can access all functions of system 10. However, nothing in the current invention necessarily limits the functions that can be performed by user 32.

Shown in memory 16 as computer program code is portal program 36. As depicted, portal program 36 includes a mapping system 38, a creation system 40, a broker system 42, and a conversion system 44. As will be further described below, mapping system 38 allows administrator 34 (or user 32) to map/link specific fields of portlets together so that data can be automatically shared therebetween. Creation system 40 allows the portlets to be initially created, and arranged/formatted into a portal page. To this extent, creation system 40 could incorporate any known system(s) for defining portlets, obtaining and aggregating web content (e.g., from content provider system 28), and formatting the created portlets into a portal page.

It is understood that these systems can be implemented on a single computer (as shown) or distributed across multiple computers. Additionally, it is understood that all programs and systems are not necessary to implement the current invention. For example, the invention can be implemented without the functionality provided by conversion system 44, as discussed below. Moreover, mapping system 38 need not be part of portal program 36. It has been shown as such for illustrative purposes only.

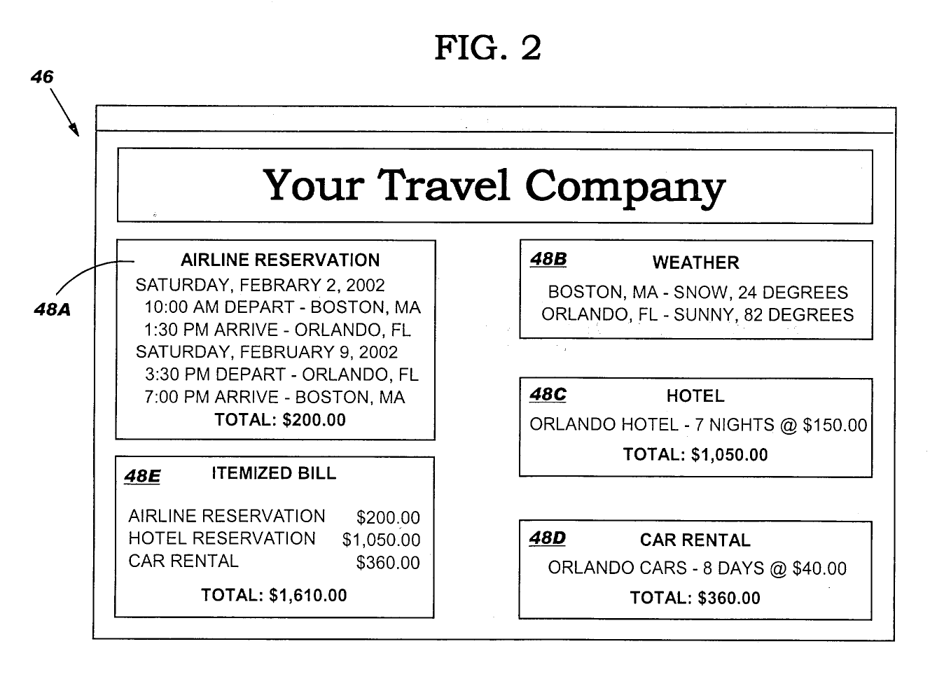

Referring now to FIG. 2, an illustrative portal page 46 generated according to one aspect of the invention is depicted. As shown, portal page 46 comprises a travel company portal page that summarizes various reservations and charges incurred for a particular trip. Portal page 46 includes a portlet 48A that summarizes an airline reservation, a portlet 48B for providing the weather at the departure and destination cities, a portlet 48C for summarizing hotel information, a portlet 48D for summarizing car rental information, and a portlet 48E for providing a summary of the total bill for the trip. As can be seen, it would be desirable to share data between several of the portlets 48A-E. For example, the weather provided in portlet 48B can be based on the departure and destination cities listed in portlet 48A. Further, portlet 48E can obtain the bill information from portlets 48A, 48C, and 48D. Additionally, it could be desirable for several of the portlets 48A-C to be incorporated into other portal pages (not shown). For example, the weather portlet 48B can be added to any portal page such as a customized “home page” for a user. Similarly, the itemized bill portlet 48E can be incorporated on another portal page that is used for purchasing items/services over the Internet. The teachings described herein are intended to include such variations.

To implement portal page 46 under the present invention, portlets 48A-E are created with the ability to receive and share data with zero or more other portlets. Returning to FIG. 1, initially, portlets 48A-E are created (and later arranged into portal page 46) using creation system 40. In creating a portlet 48A-E, the portlet developer will define the data type for each data field (i.e., character, string, real, integer, etc.) within the portlet. The developer will also define the data field as either an input field, an output field, an internal field, or an input/output field. Data fields specified as input fields or input/output fields can receive data from another portlet 48A-E or from a content provider system 28. Similarly, data fields specified as output fields or input/output fields can share data to another portlet 48A-E. Data fields specified as internal fields cannot receive or share data with either another portlet 48A-E or content provider system 28.

In generating portal page 46, the developer will use creation system 40 to select specific portlets 48A-E for display, and to define a particular layout therefor. As such, creation system 40 can provide an interface that allows the developer to adjust the display properties of each portlet 48A-E including font, color, size, location, content, form, etc.

Once the desired portlet(s) 48A-E have been created, the portal page developer can map portlets 48 using mapping system 38. Specifically, mapping system 38 allows source fields (i.e., output or input/output fields) of one portlet (e.g., 48A) to be mapped/linked to destination fields (i.e., input or input/output fields) of another portlet (e.g., 48B). When two fields are mapped, the data in the source field will be automatically shared with the destination field. To this extent, mapping system 38 typically includes a user interface that allows the developer (or user 32) to link the desired fields together. It is understood that mapping system 38, broker system 42, and/or conversion system 44 could be included as part of creation system 40. They have been separately shown herein to more clearly describe the functions thereof.

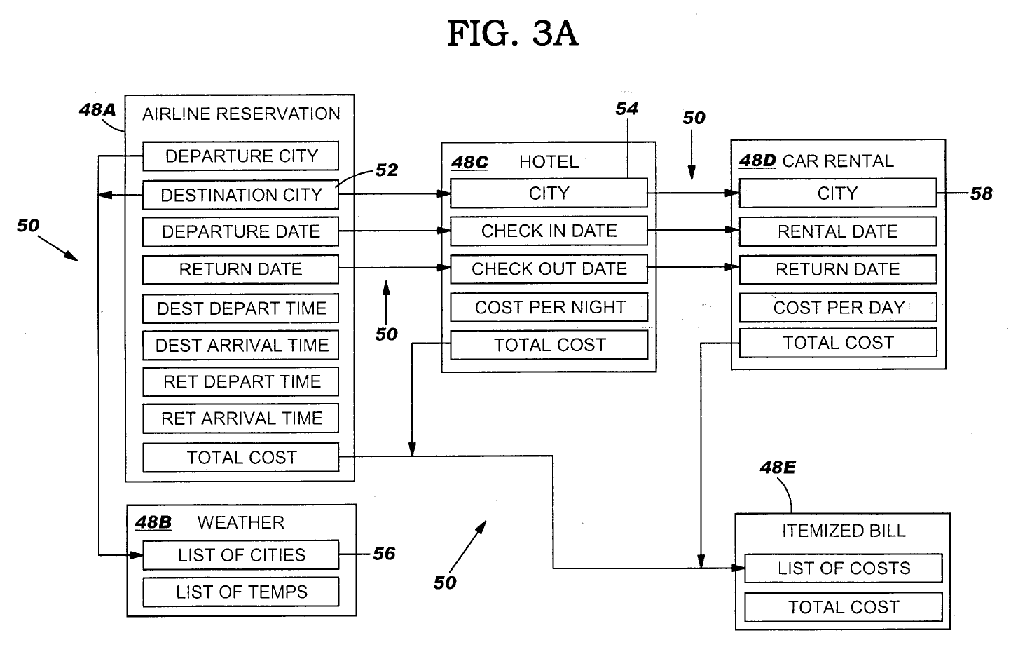

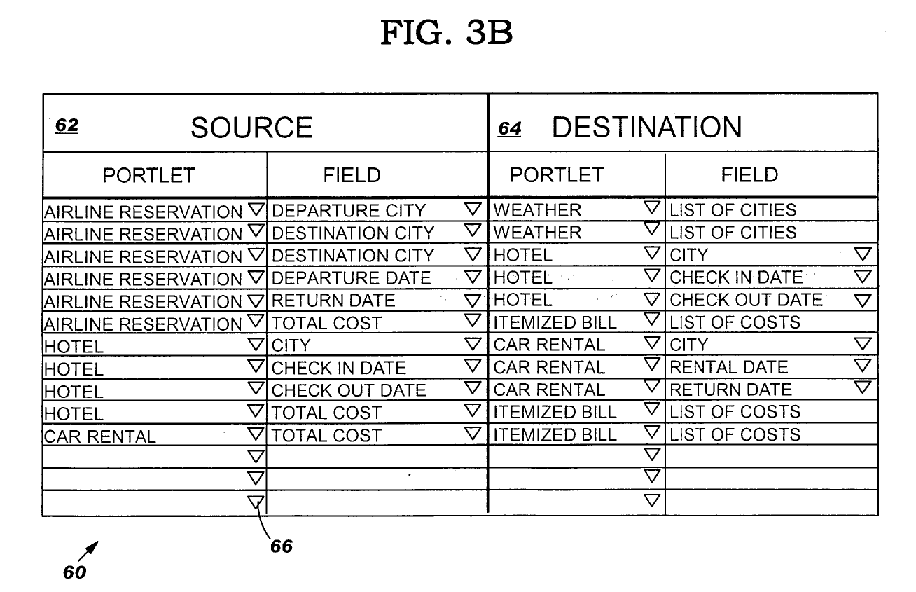

Referring to FIG. 3A, an exemplary graphical user interface for graphically mapping/linking one or more source fields to one or more destination fields is depicted. As shown, each portlet 48A-E is displayed along with the fields that have been specified as input, output, or input/output. While not shown, the display of each field can be altered depending on its I/O specification. For example, input fields, output fields, and input/output fields can each be shown in a unique color, incorporate a unique shape or marking, etc. To implement the data sharing, the portal page developer can, for example, use a mouse to graphically connect a source field of one portlet 48 to a destination field of another portlet 48. For example, destination city field 52 of portlet 48A can be graphically connected (mapped) to city field 54 of hotel portlet 48C and list of cities field 56 of weather portlet 48B. In this instance, destination city field 52 would be the source field, while city field 54 and list of cities field 56 are considered destination fields. Moreover, since city field 54 of hotel portlet 48C is mapped to city field 58 of car rental portlet 48D, city field 54 is also considered a source field and city field 58 is considered a destination field. In any event, once source and destination fields are mapped, any data in the source field(s) (e.g., Las Vegas, Nev.) will be automatically shared with the destination field. In providing correct and appropriate mappings, mapping system 38 can first ensure that the data can properly be shared (i.e., the data types are compatible and the respective fields are properly specified as input and/or output fields). If the sharing is allowed, mapping system 38 will draw a graphical representation (i.e., arrows 50) to display the mapping.

FIG. 3B depicts an alternative character-based user interface for mapping one or more source fields to one or more destination fields. As shown, a chart 60 is provided having a source side 62 and a destination side 64. A portal page developer specifies a source field by specifying both the portlet (e.g., airline reservations) and the field in the portlet (e.g., departure city). Similarly, the corresponding destination field is specified by selecting the destination portlet (e.g., weather) and the field in the portlet (list of cities). Drop down boxes 66 can be used to ensure that only valid connections are selected. For example, the portal page developer can first select a source portlet. Based on this selection, the fields defined as output or input/output fields are listed in the source field drop down box. The destination portlet and portlet field can be selected in a similar manner. When a portlet includes only a single field that is valid for the selection (i.e., the weather portlet includes only one input field, list of cities), then the field can be automatically selected for the user after the portlet is specified. Similarly, when only two portlets are included on a portal page, once one portlet is selected as a source, the second portlet can be selected as the destination. In any event, as indicated above, once a source field has been mapped to a destination field, any data in the source field will be automatically shared with the destination field.

As shown in both FIGS. 3A and 3B, it may be desirable to share data between fields having different data types. For example, airline reservation portlet 48A could output a single string for the departure city, and a single string for the destination city. However, the weather portlet 48B might only accept a list of strings (i.e., a list of cities). To address such issues, conversion system 44 can be provided as shown in FIG. 1. In general, conversion system 44 converts the shared data from a data type/format of the source field to a data type/format of the destination field. Consequently, the departure city and destination city outputs of airline reservation portlet 48A would be converted into a list of cities by conversion system 44 before being provided to the list of cities input field for weather portlet 48B. Thus, conversion system 44 also allows any number of data types to be accommodated. For example, the total cost outputs of portlets 48A, 48C, and 48D can each comprise a record that includes a string (name of the charge) and a real number (amount of charge). In order to provide such effective data conversions, conversion data is typically provided (e.g., stored in database 24) for access by conversion system 40.

Returning to FIG. 1, once portal page 46 has been defined, user 32 can specify that user system 26 display portal page 46. This may comprise, for example, displaying a custom “home page” when connecting to the Internet, completing an e-commerce transaction, etc. To display portal page 46, user system 26 contacts portal program 36. Portal program 36 communicates the portal page 46 to user system 26. User system 26 then implements the display of portal page 46, which includes executing portlets 48A-E. Alternatively, computer system 12 can generate a completed portal page 46 (i.e., execute portlets 48), and then communicate portal page 46 to user system 26 for display.

It should be understood that any data/content that is not user or developer-defined can be obtained from content provider system 28. For example, although a user will specify data such as the city of departure, the actual weather forecast for weather portlet 48B can be obtained from content provider system 28 (e.g., the national weather service). To this extent, content provider system 28 and portlets 48A-E can share data. This data sharing can be predefined in the portlet program code or can occur in a similar manner as described above with reference to the data sharing between portlets 48A-E. For example, when defining a portal page 46, the portal page developer can add a definition to the portal page that represents data provided by a particular content provider system 28. This can subsequently be displayed and mapped via mapping system 38 when defining the data sharing between portlets.

Under the present invention, each portlet 48A-E can read and write data in its own private memory space. Data sharing between portlets 48A-E can be implemented using a “notification” type messaging system. In this system, when a data value of a source field is modified, the “source” portlet sends a message to broker system 42. Broker system 42 accesses the mappings defined for the source field using mapping system 38, and sends a message to each “destination” portlet having a destination field with which the source field is shared. The message includes an identification of the destination field, and the updated data value for the destination field. When necessary, broker system 42 can use conversion system 44 to convert the data between the source field and destination field data types. The “destination” portlet then writes the new data value in its own private memory space, and executes any functions as required. It is understood, however, that broker system 42 is not necessary to implement the messaging system. For example, mapping system 38 can provide each portlet 48 with a list of “destination” portlets and fields for each shared field. A portlet 48 can then send a message directly to each “destination” portlet.

Alternatively, data sharing between portlets 48A-E can be implemented using a shared memory. In this case, a portlet 48A can write all source fields to a shared memory location. Subsequently, another portlet 48C would read the data from the shared memory location for a mapped destination field. The reading and writing can be performed using broker system 42 and/or conversion system 44 so that the required communications and data type conversions can be performed without requiring additional functionality in portlets 48A-E.

It is understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls computer system 12, user system 26, and/or content provider system 28 such that they carry out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A system for sharing data between portlets, comprising a mapping system for mapping a source field in a first portlet to a destination field in a second portlet, wherein data in the source field is shared with the destination field.

2. The system of claim 1, further comprising a creation system for creating the first portlet and the second portlet, and for arranging the first portlet and the second portlet into a portal page.

3. The system of claim 2, wherein each data field in each portlet is defined as one of: an input field, an output field, an internal field, and an input/output field.

4. The system of claim 1, wherein the mapping system provides a graphical user interface for mapping the source field to the destination field.

5. The system of claim 1, wherein the mapping system provides a character-based user interface for mapping the source field to the destination field.

6. The system of claim 1, further comprising a conversion system for converting the data from a data type of the source field to a data type of the destination field.

7. The system of claim 1, further comprising a content provider system for providing data to at least one of the first portlet and the second portlet.

8. The system of claim 1, further comprising a user system for displaying the first portlet and the second portlet as a portal page.

9. The system of claim 1, wherein the mapping system is embodied within a portal program.

10. A method of sharing data between portlets, comprising:
providing a first portlet and a second portlet;
mapping a source field in the first portlet to a destination field in the second portlet; and
sharing data in the source field with the mapped destination field.

11. The method of claim 10, further comprising creating the first portlet and the second portlet, wherein each data field in each portlet is defined as one of: an input field, an output field, an internal field, and an input/output field.

12. The method of claim 10, wherein the source field is mapped to the destination field using a graphical user interface.

13. The method of claim 10, wherein the source field is mapped to the destination field using a character-based user interface.

14. The method of claim 10, further comprising converting the data from a data type of the source field to a data type of the destination field.

15. The method of claim 10, further comprising obtaining data for the first portlet from a content provider system.

16. The method of claim 10, further comprising displaying the first portlet and the second portlet as a portal page.

17. A computer program product comprising a computer useable medium having computer readable program code embodied therein for sharing data between portlets, the program product comprising:
program code configured to define a first portlet having a source field and a second portlet having a destination field; and
program code configured to map the source field to the destination field, wherein data in the source field is shared with the destination field.

18. The computer program product of claim 17, further comprising program code configured to define each data field in each portlet as one of: an input field, an output field, an internal field, and an input/output field.

19. The computer program product of claim 17, further comprising program code configured to convert the data from a data type of the source field to a data type of the destination field.

20. The computer program product of claim 17, further comprising program code configured to define a layout of a portal page, wherein the portal page includes the first portlet and the second portlet.
